(19) United States
(12) Patent Application Publication
(10) Pub. No.: US 2013/0165052 A1
(43) Pub. Date: Jun. 27, 2013

(54) METHOD FOR ADAPTIVELY PERFORMING RADIO LINK CONTROL WITHIN A NETWORK, AND ASSOCIATED APPARATUS

(71) Applicant: Yao-Lung Chuang, New Taipei City (TW)

(72) Inventor: Yao-Lung Chuang, New Taipei City (TW)

(21) Appl. No.: 13/335,964

(22) Filed: Dec. 23, 2011

(51) Int. Cl. H04W 24/00

(52) U.S. Cl. 455/67.11

(57) ABSTRACT

A method for adaptively performing radio link control within a network and an associated apparatus are provided, where the method is applied to an electronic device. The method includes: screening a plurality of cells within the network according to recorded data of locations of the plurality of cells and according to a target location of the electronic device, to obtain cell information of at least one portion of the plurality of cells, the at least one portion of the plurality of cells being selected by screening, wherein the cell information or existence of the cell information indicates suggestion regarding whether the electronic device should use the at least one portion of the plurality of cells with respect to the target location, respectively; and based upon the cell information of the at least one portion of the plurality of cells, controlling content(s) of a measurement report being sent to the network.

### BACKGROUND

The present invention relates to prevention of radio link failure (RLF) of an electronic device, and more particularly, to a method for adaptively performing radio link control within a network, and to an associated apparatus.

According to the related art, a portable electronic device equipped with a touch screen (e.g., a multifunctional mobile phone, a personal digital assistant (PDA), a tablet, etc) can be very helpful to an end user, where the portable electronic device may be designed to be capable of performing telecommunication operations. Typically, instant measurement operations are essential for performing radio link control. In a situation where the conventional radio link control is based upon the instant measurement results regarding signal quality, some problems may occur. For example, as the end user may move (e.g. drive) around very fast when carrying the portable electronic device, the instant measurement results regarding the signal quality may not be obtained in time, causing the aforementioned RLF of the portable electronic device. In another example, it seems unlikely that the conventional control mechanism of a network can always notify the portable electronic device of some instructions in time, causing the aforementioned RLF of the portable electronic device. In conclusion, the related art does not serve the end user well. Thus, a novel method is required for enhancing radio link control of an electronic device.

### SUMMARY

It is therefore an objective of the claimed invention to provide a method for adaptively performing radio link control within a network, and to provide an associated apparatus, in order to solve the above-mentioned problems.

An exemplary embodiment of a method for adaptively performing radio link control within a network is provided, where the method is applied to an electronic device. The method comprises the steps of: screening a plurality of cells within the network according to recorded data of locations of the plurality of cells and according to a target location of the electronic device, in order to obtain cell information of at least one portion of the plurality of cells, the at least one portion of the plurality of cells being selected by screening, wherein the cell information or existence of the cell information indicates suggestion regarding whether the electronic device should use the at least one portion of the plurality of cells with respect to the target location, respectively; and based upon the cell information of the at least one portion of the plurality of cells, controlling content(s) of a measurement report being sent to the network.

An exemplary embodiment of an apparatus for adaptively performing radio link control within a network is provided, where the apparatus comprises at least one portion of an electronic device. The apparatus comprises a storage unit and a processing circuit. The storage unit is arranged to temporarily store information. In addition, the processing circuit is arranged to screen a plurality of cells within the network according to recorded data of locations of the plurality of cells and according to a target location of the electronic device, in order to obtain cell information of at least one portion of the plurality of cells, the at least one portion of the plurality of cells being selected by screening, wherein the cell information or existence of the cell information indicates suggestion regarding whether the electronic device should use the at least one portion of the plurality of cells with respect to the target location, respectively. Additionally, based upon the cell information of the at least one portion of the plurality of cells, the processing circuit controls content(s) of a measurement report being sent to the network. In particular, the cell information is selectively obtained from the storage unit or obtained from outside the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for adaptively performing radio link control within a network according to a first embodiment of the present invention.

FIG. 2 illustrates the apparatus shown in FIG. 1 according to an embodiment of the present invention, where the apparatus of this embodiment is a mobile phone.

FIG. 3 illustrates a flowchart of a method for adaptively performing radio link control within a network according to an embodiment of the present invention.

FIG. 4 illustrates a trace of a user equipment involved with the method shown in FIG. 3 according to an embodiment of the present invention.

FIGS. 5A-5B illustrate a working flow involved with the method shown in FIG. 3 according to an embodiment of the present invention.

FIG. 6 illustrates a working flow involved with the method shown in FIG. 3 according to another embodiment of the present invention.

FIG. 7 illustrates a working flow involved with the method shown in FIG. 3 according to yet another embodiment of the present invention.

FIG. 8 illustrates a working flow involved with the method shown in FIG. 3 according to still another embodiment of the present invention.

FIG. 9 illustrates a working flow involved with the method shown in FIG. 3 according to yet still another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

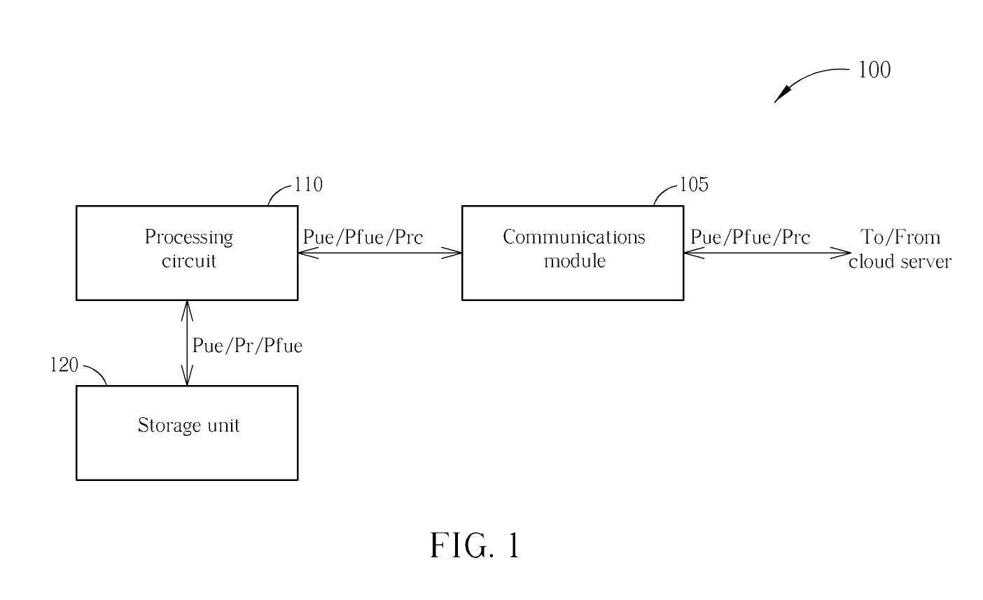

Please refer to FIG. 1, which illustrates a diagram of an apparatus 100 for adaptively performing radio link control within a network according to a first embodiment of the present invention. According to different embodiments, such as the first embodiment and some variations thereof, the apparatus 100 may comprise at least one portion (e.g. a portion or all) of an electronic device. For example, the apparatus 100 may comprise a portion of the electronic device mentioned above, and more particularly, can be a control circuit such as an integrated circuit (IC) within the electronic device. In another example, the apparatus 100 can be the whole of the electronic device mentioned above. In another example, the apparatus 100 can be an audio/video system comprising the electronic device mentioned above. Examples of the electronic device may include, but not limited to, a mobile phone (e.g. a multifunctional mobile phone), a personal digital assistant (PDA), a portable electronic device such as the so-called tablet (based on a generalized definition), and a personal computer such as a tablet personal computer (which can also be referred to as the tablet, for simplicity), a laptop computer, or desktop computer.

As shown in FIG. 1, the apparatus 100 comprises a processing circuit 110, a storage unit 120, and a communications module 105. The processing circuit 110 is arranged to control operations of the electronic device. In addition, the storage unit 120 is arranged to temporarily store information, such as information that can be accessed by the processing circuit 110 when needed. For example, the storage unit 120 can be a memory (e.g. a volatile memory such as a random access memory (RAM), or a non-volatile memory such as a Flash memory), or can be a hard disk drive (HDD). Additionally, the communications module 105 is arranged to perform communications operations (more particularly, wireless communications operations) for the processing circuit 110, and therefore, the processing circuit 110 can access a cloud server through the communications module 105. For example, the processing circuit 110 can store information in the cloud server in advance. As a result, the end user can share the information on the cloud server with others or utilize the information in the cloud server (e.g. the information stored by the processing circuit 110 through the communications module 105, or the information stored by other electronic devices or by a certain system, or the information shared by other users) when needed. Please note that various sets of information, such as {Pue}, {Pfue}, {Pr}, and {Prc} (elements of which are respectively labeled “Pue”, “Pfue”, “Pr”, and “Prc”, and are explained in some embodiments/variations of the present invention in the following descriptions), can be taken as examples of the information to be stored/retrieved. More particularly, a plurality of sets of information, such as {Pue}, {Pfue}, and {Pr}, can be taken as examples of the information that the processing circuit 110 temporarily stores into the storage unit 120, and can be taken as examples of the information that the processing circuit 110 retrieves from the storage unit 120. In addition, a plurality of sets of information, such as {Pue}, {Pfue}, and {Prc}, can be taken as examples of the information that the processing circuit 110 stores into the cloud server through the communications module 105, and can be taken as examples of the information that the processing circuit 110 retrieves from the cloud server through the communications module 105.

According to this embodiment, the processing circuit 110 is arranged to screen a plurality of cells (or base stations) within the network according to recorded data of locations of the plurality of cells and according to a target location of the electronic device, in order to obtain cell information of at least one portion (e.g. a portion or all) of the plurality of cells. More specifically, the aforementioned at least one portion of the plurality of cells is selected by screening, i.e. the screening operation performed by the processing circuit 110. In particular, the cell information or existence of the cell information may indicate suggestion regarding whether the electronic device should use the aforementioned at least one portion of the plurality of cells with respect to the target location, respectively. Additionally, based upon the cell information of the aforementioned at least one portion of the plurality of cells, the processing circuit 110 is arranged to control content(s) of a measurement report being sent to the network. In practice, the cell information can selectively be obtained from the storage unit 120 or obtained from outside the electronic device (e.g. from the cloud server mentioned above). Similarly, the recorded data can selectively be obtained from the storage unit 120 or obtained from outside the electronic device (e.g. from the cloud server mentioned above).

Please note that the target location mentioned above can be arbitrary set by the processing circuit 110 when needed. For example, the target location can be a current location of the electronic device. In another example, the target location can be a planned location of the electronic device, where the processing circuit 110 can temporarily determine the planned location to be a location on a trace of a travel plan set in the electronic device. Typically, under control of the processing circuit 110, at least one portion (e.g. a portion or all) of the trace can be displayed on a screen (not shown in FIG. 1) of the electronic device, where the planned location mentioned above can be a point on the trace.

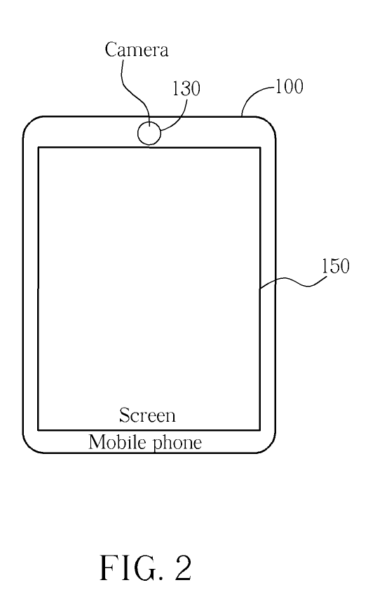

FIG. 2 illustrates the apparatus 100 shown in FIG. 1 according to an embodiment of the present invention, where the apparatus 100 of this embodiment is a mobile phone, and therefore, is labeled “Mobile phone” in FIG. 2. A camera module 130 (labeled “Camera” in FIG. 2, for brevity) is installed within the apparatus 100 mentioned above (i.e. the mobile phone in this embodiment), which means the apparatus 100 comprises the camera module 130. In addition, a touch screen 150 (labeled “Screen” in FIG. 2, for brevity) is taken as an example of the screen mentioned in the first embodiment, and is installed within the apparatus 100 mentioned above, which means the apparatus 100 comprises the touch screen 150. In this embodiment, as the processing circuit 110, the storage unit 120, and the communications module 105 are internal components of the mobile phone, they are not shown in FIG. 2.

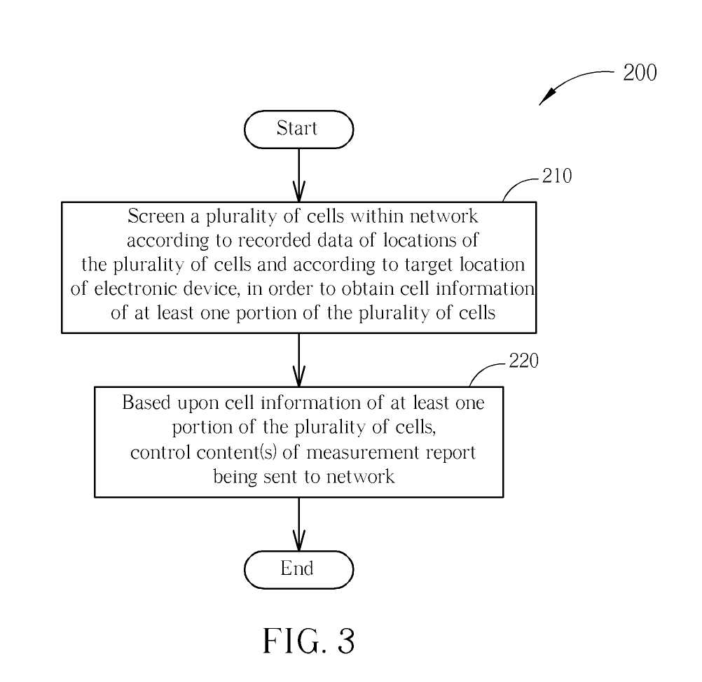

FIG. 3 illustrates a flowchart of a method 200 for adaptively performing radio link control within a network such as that mentioned above according to an embodiment of the present invention. The method 200 shown in FIG. 3 can be applied to the apparatus 100 shown in FIG. 1, and more particularly, the processing circuit 110 mentioned above. The method is described as follows.

In Step 210, the processing circuit 110 screens a plurality of cells within the network, such as the plurality of cells mentioned above, according to the recorded data of the locations of the plurality of cells and according to the target location of the electronic device, in order to obtain the cell information of the aforementioned at least one portion of the plurality of cells (more particularly, the aforementioned at least one portion of the plurality of cells being selected by screening, such as one or more cells selected from the plurality of cells by screening). For example, the cell information indicates suggestion regarding whether the electronic device should use the aforementioned at least one portion of the plurality of cells (e.g. one or more cells thereof) with respect to the target location, respectively. In another example, the existence of the cell information indicates suggestion regarding whether the electronic device should use the aforementioned at least one portion of the plurality of cells (e.g. one or more cells thereof) with respect to the target location, respectively.

In Step 220, based upon the cell information of the aforementioned at least one portion of the plurality of cells, the processing circuit 110 controls content(s) of a measurement report being sent to the network, such as the measurement report mentioned in the first embodiment. As a result, the network may add/delete/replace at least one cell according to the measurement report. For example, based upon the cell information, the processing circuit 110 may add/prevent adding at least one cell into the content(s) of the measurement report, and therefore, the network may operate according to the measurement report. In another example, based upon the cell information, the processing circuit 110 may delete/prevent deleting at least one cell in the content(s) of the measurement report, and therefore, the network may operate according to the measurement report. In another example, based upon the cell information, the processing circuit 110 may replace/prevent replacing at least one cell in the content(s) of the measurement report, and therefore, the network may operate according to the measurement report. In some situations, the content(s) of the measurement report may be controlled in response to the so-called “event 1A” complying with Wideband Code Division Multiple Access (WCDMA) standards, the so-called “event 1B” complying with WCDMA standards, and the so-called “event 1C” complying with WCDMA standards. This is for illustrative purposes only, and is not meant to be a limitation of the present invention. The measurement report can simply be the measurement report complying with the so-called second generation (2G) standards.

According to this embodiment, the processing circuit 110 can record the recorded data mentioned in Step 210 (e.g. the recorded data of the locations of the plurality of cells) in advance. For example, the processing circuit 110 records the recorded data in the electronic device (more particularly, in the storage unit 120) in advance. In another example, the processing circuit 110 records the recorded data in the cloud server mentioned above through the communications module 105 in advance. In addition to the recorded data mentioned above, the processing circuit 110 can further record at least one portion of the aforementioned cell information. For example, the processing circuit 110 records the cell information in the electronic device (more particularly, in the storage unit 120) in advance. In another example, the processing circuit 110 records the cell information in the cloud server mentioned above through the communications module 105 in advance. As a result, when needed, the processing circuit 110 can retrieve the recorded data and the cell information from the cloud server in a situation where the electronic device is connected to the cloud server, or retrieve the recorded data and the cell information from the storage unit 120 in a situation where the cloud server is not available.

In practice, for a cell under consideration within the plurality of cells (e.g. any of the plurality of cells), the cell information may comprise the recorded data of an instantaneous location of the cell under consideration, where the recorded data of the instantaneous location of the cell under consideration is recorded in a situation where the signal quality of the cell under consideration is greater than a predetermined threshold. Thus, in a situation where the cell under consideration is selected from the plurality of cells by screening in Step 210, the existence of the recorded data of the instantaneous location of the cell under consideration may indicate suggestion of using the cell under consideration with respect to the target location. In addition, the cell information of the aforementioned cell under consideration may comprise other information. For example, regarding the aforementioned 2G standards, for the cell under consideration within the plurality of cells, the cell information may further comprise an absolute radio frequency channel number (ARFCN), a location area code (LAC) and a routing area code (RAC), a public land mobile network (PLMN), and a base station identity code (BSIC) and a frame number. In another example, regarding the so-called third generation (3G) standards, for the cell under consideration within the plurality of cells, the cell information may further comprise an universal mobile telecommunications system (UMTS) terrestrial radio access (UTRA) ARFCN, which can be referred to as UARFCN for brevity, a primary synchronization code (PSC) of a synchronization channel (SCH), a secondary synchronization code of the SCH, and a PLMN.

According to some embodiments, such as some variations of this embodiment, both of the network and the electronic device comply with some Global System for Mobile Communications (GSM) standards, where the measurement report mentioned in Step 220 can be one of a plurality of measurement reports supposed to be periodically sent to a base station controller (BSC) within the network. More particularly, in a situation where the processing circuit 110 is not able to completely prepare the plurality of measurement reports as required (e.g. the processing circuit 110 does not have enough time to perform associated measurements, or the processing circuit 110 cannot find out a cell having the best signal quality), the processing circuit 110 can utilize preloaded good cell information (e.g. the cell information of one or more of the plurality of cells) to prepare the measurement report mentioned in Step 220, and send the measurement report to a base transceiver station (BTS). As a result, the BSC can analyze the measurement reports of the electronic device and some base stations in advance to select one of the base stations for serving the electronic device, in order to reduce the probability of occurrence of the aforementioned radio link failure (RLF).

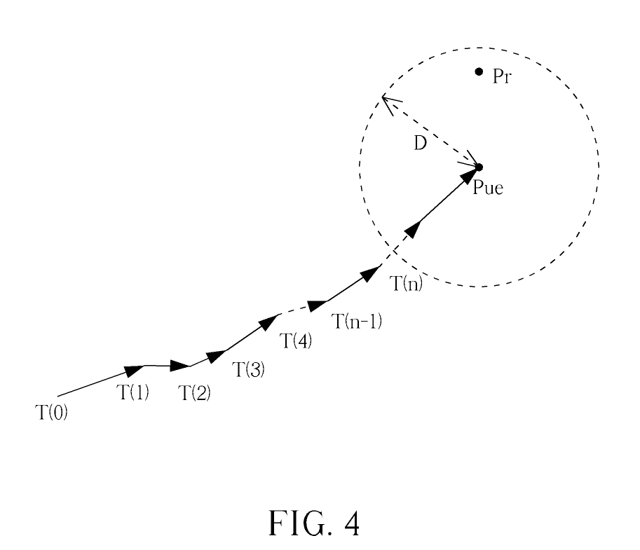

FIG. 4 illustrates a trace of a user equipment (UE) involved with the method 200 shown in FIG. 3 according to an embodiment of the present invention. The UE of this embodiment (and some variations thereof) can be taken as an example of the electronic device of the first embodiment (e.g. the mobile phone shown in FIG. 2). Please note that the notation “Pue” is utilized for representing the location where the UE stays, and the notation “Pr” is utilized for representing the location of the cell under consideration, such as the location of the base station therein, where the upper case “P” of these notations (e.g. Pue and Pr) stands for the position/location, and the lower case “r” of the notation “Pr” stands for the recorded data. In addition, the notation “T” is utilized for representing time, where the sequence thereof comprise a plurality of elements {T(•)}, such as T(0), T(1), T(2), T(3), T(4), . . . , T(n−1), T(n)}, etc., which can be regarded as a plurality of time points respectively corresponding to some possible target locations of the electronic device. For example, at the time point T(0), the target location of the electronic device such as the UE can be referred to as Pue(0). In another example, at the time point T(n), the target location of the electronic device such as the UE can be referred to as Pue(n). For brevity, at a moment under consideration, the target location of the electronic device such as the UE can simply be referred to as Pue.

According to this embodiment, within the plurality of cells, the processing circuit 110 selects those that are within a predetermined range around the target location as the aforementioned at least one portion of the plurality of cells. For example, the predetermined range can be defined as a circle having a radius D, where the center of the circle can be defined as the target location. As shown in FIG. 4, the location Pr of the cell under consideration (e.g. the location of the base station therein) is within the circle centered at the target location Pue of the electronic device such as the UE, i.e. the circle having the radius D in FIG. 4. Here, the notation “Distance(Pue, Pr)” can be utilized for representing the distance between the target location Pue and the location Pr. Thus, for the cell under consideration (whose location is Pr) in the situation shown in FIG. 4, Distance(Pue, Pr)<D. This is for illustrative purposes only, and is not meant to be a limitation of the present invention. According to this embodiment (and some variations thereof), when it is detected that Distance(Pue, Pr)≦D during the screening operation disclosed in Step 210, the processing circuit 110 obtains the cell information of the cell under consideration. For example, the processing circuit 110 may obtain the cell information of the cell under consideration by retrieving the cell information from the cloud server in a situation where the cloud server is available. In another example, the processing circuit 110 may obtain the cell information of the cell under consideration by retrieving the cell information from the storage unit 120 in a situation where the cloud server is unavailable.

In practice, the radius D may be varied in response to the change in the speed Vue of the UE. More particularly, the processing circuit 110 may increase the radius D when the speed Vue increases, and may decrease the radius D when the speed Vue decreases. In order to estimate the speed Vue, the processing circuit 110 can perform some calculations according to global navigation satellite system (GNSS) signals such as global positioning system (GPS) signals. For example, based upon the calculations, the processing circuit 110 may estimate or determine the speed Vue as follows:

Vue(n)=Distance(Pue(n), Pue(n−1))/(T(n)−T(n−1));

where the notation “Distance(Pue(n), Pue(n−1))” represents the distance between the target locations Pue(n) and Pue(n−1).

For simplifying the calculations, the processing circuit 110 may operate based upon the assumption of:

T(1)−T(0)=T(2)−T(1)= . . . =T(n)−T(n−1)=T(n+1)−T(n)= . . . ;

Thus, the processing circuit 110 may estimate or determine the displacement distance Distance(Pue(n+1), Pue(n)) corresponding to the next time interval [T(n), T(n+1)] as follows:

Distance(Pue(n+1), Pue(n))=Vue(n)*(T(n+1)−T(n));

where the displacement distance Distance(Pue(n+1), Pue(n)) is estimated to be the same as the displacement distance Distance(Pue(n), Pue(n−1)) according to the assumption mentioned above.

According to different embodiments, such as this embodiment and some variations thereof, the trace shown in FIG. 4 may comprise a predetermined trace of the UE (e.g. the trace of the aforementioned travel plan), a real trace of the UE, and/or a combination of at least one predetermined trace of the UE (e.g. at least one portion of the trace of the aforementioned travel plan) and at least one real trace of the UE. For example, the trace shown in FIG. 4 can be a predetermined trace of the UE, such as the trace of the travel plan mentioned above. In another example, the trace shown in FIG. 4 can be a real trace of the UE. In another example, the trace shown in FIG. 4 can be a combination of at least one predetermined trace of the UE (e.g. at least one portion of the trace of the travel plan mentioned above) and at least one real trace of the UE.

Please note that no matter whether the trace shown in FIG. 4 comprises the predetermined trace of the UE (e.g. the trace of the aforementioned travel plan), the real trace of the UE, or the combination of at least one predetermined trace of the UE (e.g. at least one portion of the trace of the aforementioned travel plan) and at least one real trace of the UE, implementation of these embodiments will not be hindered. In general, the target location mentioned above can be arbitrary set by the processing circuit 110 when needed. For example, the target location can be the aforementioned current location of the electronic device. In another example, the target location can be the aforementioned planned location of the electronic device.

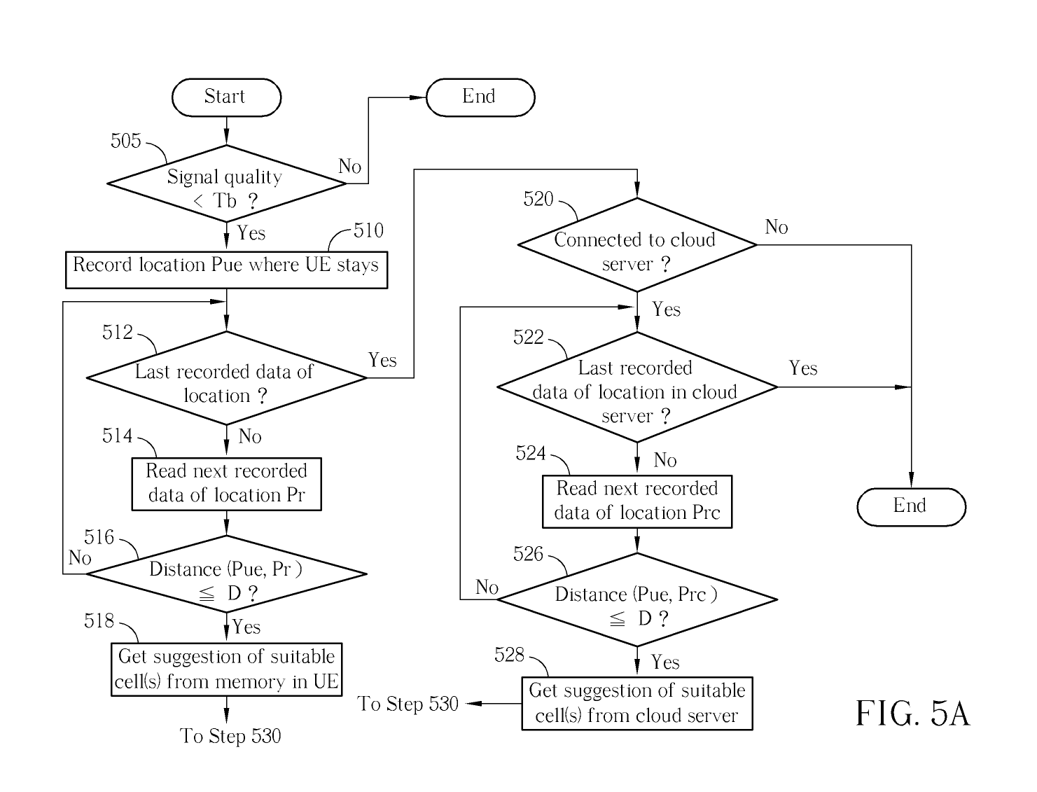

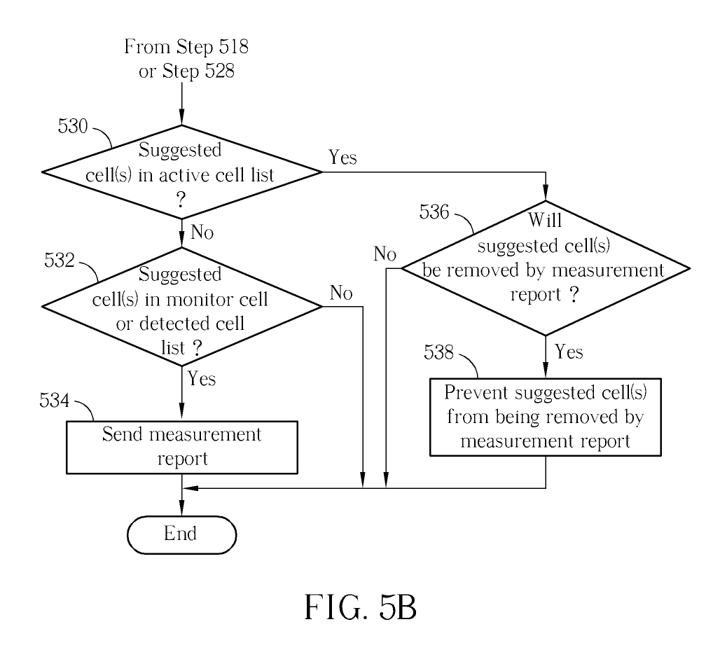

Please refer to FIGS. 5A-5B, which illustrate a working flow 500 involved with the method 200 shown in FIG. 3 according to an embodiment of the present invention.

Referring to FIG. 5A, in Step 505, the processing circuit 110 checks whether the signal quality is less than a predetermined threshold Tb. For example, the notation “Qs” represents a signal quality index of the signal quality mentioned above, and the processing circuit 110 can determine the signal quality (more particularly, the signal quality index Qs) according to some parameters Ec/No, SIR, RSCP, RSSI, P_{TX}, CQI, etc. as follows:

Qs=((W1*Ec/No)+(W2*SIR)+(W3*RSCP)+(W4*P_{TX})+(W5*CQI)+ . . . )/(W1+W2+W3+W4+W5+ . . . );

where the notations W1, W2, W3, W4, W5, etc. represent weighting factors, the parameters SIR, RSCP, RSSI, P_{TX}, and CQI respectively represent the signal-to-interference ratio, the received signal code power, the received signal strength indicator, the transceiver (TX) power, and the channel quality indicator, and the parameter Ec/No represents the ratio of the parameter RSCP to the parameter RSSI. For example, each of the weighting factors W1, W2, W3, W4, W5, etc. may fall within a range of the interval [0, 1]. When it is detected that the signal quality is less than the predetermined threshold Tb (e.g. Qs<Tb), Step 510 is entered; otherwise, the working flow 500 comes to the end.

In Step 510, the processing circuit 110 records the location Pue where the UE stays.

In Step 512, the processing circuit 110 checks whether the last recorded data of location within the set of recorded data under consideration (more particularly, the set of recorded data in the storage unit 120) is reached. In practice, regarding the set of recorded data under consideration, in a situation where there is no recorded data in the storage unit 120, it can be considered to be the case that the last recorded data of location is reached. When it is detected that the last recorded data of location within the set of recorded data under consideration is reached, Step 520 is entered; otherwise, Step 514 is entered.

In Step 514, the processing circuit 110 reads the next recorded data of location Pr.

In Step 516, the processing circuit 110 checks whether Distance(Pue, Pr)≦D. When it is detected that Distance(Pue, Pr)≦D, Step 518 is entered; otherwise, Step 512 is re-entered.

In Step 518, the processing circuit 110 gets the suggestion of suitable cell(s) from a memory in the UE, where the memory mentioned in Step 518 can be taken as an example of the storage unit 120. For example, the cell information mentioned in Step 210 indicates the suggestion regarding whether the electronic device should use the aforementioned at least one portion of the plurality of cells (e.g. one or more cells thereof) with respect to the target location, respectively. In another example, the existence of the cell information mentioned in Step 210 indicates suggestion regarding whether the electronic device should use the aforementioned at least one portion of the plurality of cells (e.g. one or more cells thereof) with respect to the target location, respectively.

In Step 520, the processing circuit 110 checks whether the UE is connected to the cloud server. When it is detected that the UE is connected to the cloud server, Step 522 is entered; otherwise, the working flow 500 comes to the end.

In Step 522, the processing circuit 110 checks whether the last recorded data of location within the set of recorded data under consideration (more particularly, the set of recorded data in the cloud server) is reached. In practice, regarding the set of recorded data under consideration, in a situation where there is no recorded data in the cloud server, it can be considered to be the case that the last recorded data of location is reached. When it is detected that the last recorded data of location within the set of recorded data under consideration in the cloud server is reached, the working flow 500 comes to the end; otherwise, Step 524 is entered.

In Step 524, the processing circuit 110 reads the next recorded data of location Prc, which may have similar meaning as that of the aforementioned location Pr, where the lower case “c” of this notation (i.e. Prc) stands for the cloud server.

In Step 526, the processing circuit 110 checks whether Distance(Pue, Prc)≦D. When it is detected that Distance(Pue, Prc)≦D, Step 528 is entered; otherwise, Step 522 is re-entered.

In Step 528, the processing circuit 110 gets the suggestion of suitable cell(s) from the cloud server. For example, the cell information mentioned in Step 210 indicates the suggestion regarding whether the electronic device should use the aforementioned at least one portion of the plurality of cells (e.g. one or more cells thereof) with respect to the target location, respectively. In another example, the existence of the cell information mentioned in Step 210 indicates suggestion regarding whether the electronic device should use the aforementioned at least one portion of the plurality of cells (e.g. one or more cells thereof) with respect to the target location, respectively.

Referring to FIG. 5B, in Step 530, the processing circuit 110 checks whether the suggested cell(s) is in the active cell list. When it is detected that the suggested cell(s) is in the active cell list, Step 536 is entered; otherwise, Step 532 is entered.

In Step 532, the processing circuit 110 checks whether the suggested cell(s) is in the monitor cell or the detected cell list. When it is detected that the suggested cell(s) is in the monitor cell or the detected cell list, Step 534 is entered; otherwise, the working flow 500 comes to the end.

In Step 534, the processing circuit 110 sends the measurement report (e.g. in case of the event 1A or the event 1C complying with WCDMA standards).

In Step 536, the processing circuit 110 checks whether the suggested cell(s) will be removed by the measurement report. When it is detected that the suggested cell(s) will be removed by the measurement report, Step 538 is entered; otherwise, the working flow 500 comes to the end.

In Step 538, the processing circuit 110 prevents the suggested cell(s) from being removed by the measurement report (e.g. in case of the event 1B complying with WCDMA standards). More particularly, the processing circuit 110 prevents deleting the suggested cell(s) in the content(s) of the measurement report.

According to a variation of this embodiment, within the working flow 500, the steps shown in FIG. 5B (i.e. Steps 530 through to Step 538) can be replaced by Step 530′ in a situation where the apparatus 100 is supposed to operate in accordance with the 2G standards. In Step 530′, the processing circuit 110 sends the measurement report (e.g. the measurement report complying with the 2G standards). For example, the processing circuit 110 may determine the content(s) of the measurement report according to the suggestion disclosed in Step 518 or the suggestion disclosed in Step 528.

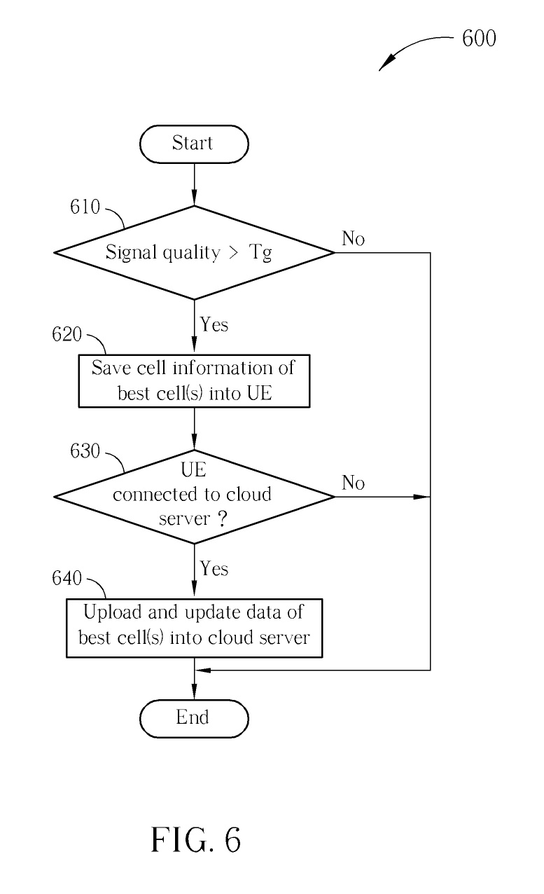

FIG. 6 illustrates a working flow 600 involved with the method 200 shown in FIG. 3 according to another embodiment of the present invention. The working flow 600 can be utilized for updating data to the cloud server if the UE is connected to the cloud server already.

In Step 610, the processing circuit 110 checks whether the signal quality is greater than a predetermined threshold Tg. For example, the processing circuit 110 can determine the signal quality (more particularly, the signal quality index Qs) according to the parameters Ec/No, SIR, RSCP, RSSI, P_{TX}, CQI, etc. mentioned above. When it is detected that the signal quality is greater than the predetermined threshold Tg (e.g. Qs>Tg), Step 620 is entered; otherwise, the working flow 600 comes to the end.

In Step 620, the processing circuit 110 saves the cell information of the best cell(s) (e.g. the cell(s) corresponding to the best signal quality, such as the cell(s) whose signal quality index Qs is greater than the predetermined threshold Tg) into the UE. Examples of the cell information of the best cell(s) may comprise the aforementioned UARFCN and the aforementioned PSC in a situation where the apparatus 100 is supposed to operate in accordance with the WCDMA standards.

In Step 630, the processing circuit 110 checks whether the UE is connected to the cloud server. When it is detected that the UE is connected to the cloud server, Step 640 is entered; otherwise, the working flow 600 comes to the end.

In Step 640, the processing circuit 110 uploads and updates the data of the best cell(s) into the cloud server.

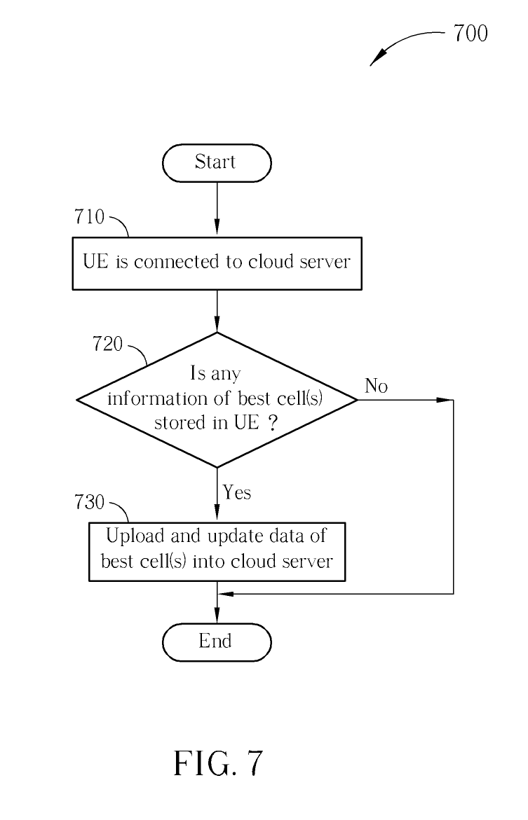

FIG. 7 illustrates a working flow 700 involved with the method 200 shown in FIG. 3 according to yet another embodiment of the present invention. The working flow 700 can be utilized for updating data to the cloud server when the UE is connected to the cloud server.

In Step 710, triggered by the user, the UE is connected to the cloud server.

In Step 720, the processing circuit 110 checks whether any information of the best cell(s) (e.g. the cell(s) corresponding to the best signal quality, such as the cell(s) whose signal quality index Qs is greater than the predetermined threshold Tg when the cell information thereof is recorded/saved) is stored in the UE. When it is detected that the information of the best cell(s) is stored in the UE, Step 730 is entered; otherwise, the working flow 700 comes to the end.

In Step 730, the processing circuit 110 uploads and updates the data of the best cell(s) into the cloud server.

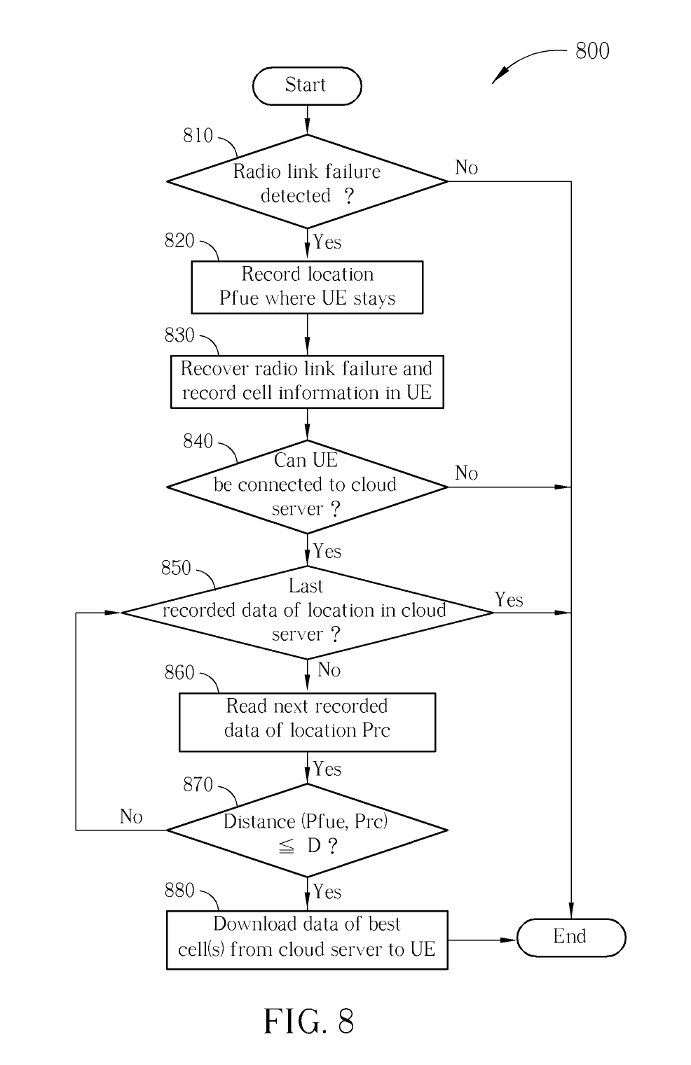

FIG. 8 illustrates a working flow 800 involved with the method 200 shown in FIG. 3 according to still another embodiment of the present invention. The working flow 800 can be utilized for downloading data from the cloud server if the UE is connected to the cloud server already.

In Step 810, the processing circuit 110 checks whether radio link failure (or RLF) is detected. When RLF is detected, Step 820 is entered; otherwise, the working flow 800 comes to the end.

In Step 820, the processing circuit 110 records the location Pfue where the UE stays. Please note that the location Pfue is typically a location that is recorded when the aforementioned RLF occurs, and the lower case “f” of this notation (i.e. Pfue) stands for failure.

In Step 830, the processing circuit 110 recovers radio link failure (or RLF) and records the cell information in the UE. Examples of the cell information may comprise the aforementioned UARFCN and the aforementioned PSC in a situation where the apparatus 100 is supposed to operate in accordance with the WCDMA standards.

In Step 840, the processing circuit 110 checks whether the UE can be connected to the cloud server. When it is detected that the UE can be connected to the cloud server, Step 850 is entered; otherwise, the working flow 800 comes to the end.

In Step 850, the processing circuit 110 checks whether the last recorded data of location within the set of recorded data under consideration in the cloud server is reached. In practice, regarding the set of recorded data under consideration, in a situation where there is no recorded data in the cloud server, it can be considered to be the case that the last recorded data of location is reached. When it is detected that the last recorded data of location within the set of recorded data under consideration in the cloud server is reached, the working flow 800 comes to the end; otherwise, Step 860 is entered.

In Step 860, the processing circuit 110 reads the next recorded data of location Prc.

In Step 870, the processing circuit 110 checks whether Distance(Pfue, Prc)≦D. When it is detected that Distance(Pfue, Prc)≦D, Step 880 is entered; otherwise, Step 850 is re-entered.

In Step 880, the processing circuit 110 downloads the data of the best cell(s) from the cloud server to the UE.

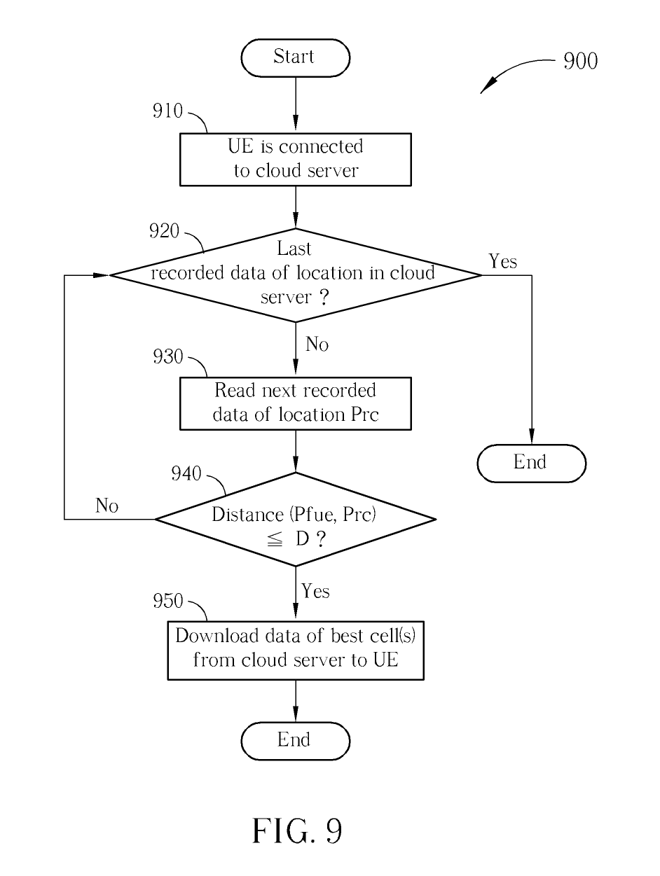

FIG. 9 illustrates a working flow 900 involved with the method 200 shown in FIG. 3 according to yet still another embodiment of the present invention. The working flow 900 can be utilized for downloading data from the cloud server when the UE is connected to the cloud server.

In Step 910, triggered by the user, the UE is connected to the cloud server.

In Step 920, the processing circuit 110 checks whether the last recorded data of location within the set of recorded data under consideration in the cloud server is reached. In practice, regarding the set of recorded data under consideration, in a situation where there is no recorded data in the cloud server, it can be considered to be the case that the last recorded data of location is reached. When it is detected that the last recorded data of location within the set of recorded data under consideration in the cloud server is reached, the working flow 900 comes to the end; otherwise, Step 930 is entered.

In Step 930, the processing circuit 110 reads the next recorded data of location Prc.

In Step 940, the processing circuit 110 checks whether Distance(Pfue, Prc)≦D. When it is detected that Distance(Pfue, Prc)≦D, Step 950 is entered; otherwise, Step 920 is re-entered.

In Step 950, the processing circuit 110 downloads the data of the best cell(s) from the cloud server to the UE.

It is an advantage of the present invention that the present invention method and apparatus allow the user to freely move (e.g. drive) around at high speed or travel by any high speed train without encountering the aforementioned RLF. As a result, the user can enjoy his/her communication by using the electronic device implemented according to any of the embodiments/variations disclosed above, where the related art problems will no longer be an annoying issue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for adaptively performing radio link control within a network, the method being applied to an electronic device, the method comprising the steps of:
screening a plurality of cells within the network according to recorded data of locations of the plurality of cells and according to a target location of the electronic device, in order to obtain cell information of at least one portion of the plurality of cells, the at least one portion of the plurality of cells being selected by screening, wherein the cell information or existence of the cell information indicates suggestion regarding whether the electronic device should use the at least one portion of the plurality of cells with respect to the target location, respectively; and
based upon the cell information of the at least one portion of the plurality of cells, controlling content(s) of a measurement report being sent to the network.

2. The method of claim 1, further comprising:
recording the recorded data in advance.

3. The method of claim 2, wherein the step of recording the recorded data in advance further comprises:
recording the recorded data in the electronic device or a cloud server in advance.

4. The method of claim 2, wherein the step of recording the recorded data in advance further comprises:
recording at least one portion of the cell information in advance.

5. The method of claim 1, wherein the step of screening the plurality of cells within the network according to the recorded data of the locations of the plurality of cells and according to the target location of the electronic device in order to obtain the cell information of the at least one portion of the plurality of cells further comprises:
within the plurality of cells, selecting those that are within a predetermined range around the target location as the at least one portion of the plurality of cells.

6. The method of claim 1, wherein for a cell under consideration within the plurality of cells, the cell information comprises:
recorded data of an instantaneous location of the cell under consideration, wherein the recorded data of the instantaneous location of the cell under consideration is recorded in a situation where signal quality of the cell under consideration is greater than a predetermined threshold.

7. The method of claim 6, wherein for the cell under consideration within the plurality of cells, the cell information further comprises:
an universal mobile telecommunications system (UMTS) terrestrial radio access absolute radio frequency channel number (UTRA absolute radio frequency channel number, UARFCN);
a primary synchronization code of a synchronization channel (SCH), and a secondary synchronization code of the SCH; and
a public land mobile network (PLMN).

8. The method of claim 6, wherein for the cell under consideration within the plurality of cells, the cell information further comprises:
an absolute radio frequency channel number (ARFCN);
a location area code (LAC) and a routing area code (RAC);
a public land mobile network (PLMN);
a base station identity code (BSIC); and
a frame number.

9. The method of claim 1, wherein the target location is a current location of the electronic device.

10. The method of claim 1, wherein the target location is a planned location of the electronic device; and the method further comprises:
temporarily determining the planned location to be a location on a trace of a travel plan set in the electronic device.

11. An apparatus for adaptively performing radio link control within a network, the apparatus comprising at least one portion of an electronic device, the apparatus comprising:
a storage unit arranged to temporarily store information; and
a processing circuit arranged to screen a plurality of cells within the network according to recorded data of locations of the plurality of cells and according to a target location of the electronic device, in order to obtain cell information of at least one portion of the plurality of cells, the at least one portion of the plurality of cells being selected by screening, wherein the cell information or existence of the cell information indicates suggestion regarding whether the electronic device should use the at least one portion of the plurality of cells with respect to the target location, respectively, and based upon the cell information of the at least one portion of the plurality of cells, the processing circuit controls content(s) of a measurement report being sent to the network;
wherein the cell information is selectively obtained from the storage unit or obtained from outside the electronic device.

12. The apparatus of claim 11, wherein the processing circuit records the recorded data in advance.

13. The apparatus of claim 12, wherein the processing circuit records the recorded data in the electronic device or a cloud server in advance.

14. The apparatus of claim 12, wherein the processing circuit records at least one portion of the cell information in advance.

15. The apparatus of claim 11, wherein within the plurality of cells, the processing circuit selects those that are within a predetermined range around the target location as the at least one portion of the plurality of cells.

16. The apparatus of claim 11, wherein for a cell under consideration within the plurality of cells, the cell information comprises:
recorded data of an instantaneous location of the cell under consideration, wherein the recorded data of the instantaneous location of the cell under consideration is recorded in a situation where signal quality of the cell under consideration is greater than a predetermined threshold.

17. The apparatus of claim 16, wherein for the cell under consideration within the plurality of cells, the cell information further comprises:
an universal mobile telecommunications system (UMTS) terrestrial radio access absolute radio frequency channel number (UTRA absolute radio frequency channel number, UARFCN);
a primary synchronization code of a synchronization channel (SCH), and a secondary synchronization code of the SCH; and
a public land mobile network (PLMN).

18. The apparatus of claim 16, wherein for the cell under consideration within the plurality of cells, the cell information further comprises:
an absolute radio frequency channel number (ARFCN);
a location area code (LAC) and a routing area code (RAC);
a public land mobile network (PLMN);
a base station identity code (BSIC); and
a frame number.

19. The apparatus of claim 11, wherein the target location is a current location of the electronic device.

20. The apparatus of claim 11, wherein the target location is a planned location of the electronic device; and the processing circuit temporarily determines the planned location to be a location on a trace of a travel plan set in the electronic device.
